(19) United States
(12) Patent Application Publication
(10) Pub. No.: US 2026/0043974 A1
(43) Pub. Date: Feb. 12, 2026

(54) COUPLING DEVICE FOR MULTI-CHANNEL OPTICAL FIBER ARRAY AND MULTI-LAYER ARRAYED WAVEGUIDE GRATING AND OPTICAL TRANSCEIVER MODULE

(71) Applicant: ACCELIGHT TECHNOLOGIES (WUHAN) INC., Wuhan (CN)

(72) Inventors: GONG-EN GU, Wuhan (CN); MICHAEL XIAOYAN WEI, Wuhan (CN); William Sterling, Wuhan (CN); Meirong ZHANG, Wuhan (CN)

(73) Assignee: ACCELIGHT TECHNOLOGIES (WUHAN) INC., Wuhan (CN)

(21) Appl. No.: 19/361,918

(22) Filed: Oct. 17, 2025

(30) Foreign Application Priority Data
Oct. 31, 2024 (CN) 202411538016.8

(51) Int. Cl. G02B 6/42

(52) U.S. Cl. CPC G02B 6/424; G02B 6/4244; G02B 6/4246

(57) ABSTRACT

A coupling device for a multi-channel optical fiber array and a multi-layer arrayed waveguide grating, includes: a first clamping component and a second clamping component. A plurality of optical fibers that are spaced apart in an X-axis direction are connected on the first clamping component, each optical fiber extends in a Y-axis direction, and a plurality of arrayed waveguide gratings that are spaced apart in the X-axis direction are connected on the second clamping component. Each arrayed waveguide grating extends in the Y-axis direction, the optical fibers and the arrayed waveguide gratings are disposed in a one-to-one coaxial mapping manner, each arrayed waveguide grating is right-trapezoid-shaped, and beveled surfaces of any two arrayed waveguide gratings are located on a same plane. A wavelength division multiplexing technology is combined with a multi-channel parallel transmission technology.

### CROSS-REFERENCE TO RELATED APPLICATIONS

This application claims priority to Chinese Patent Application No. 202411538016.8 with a filing date of Oct. 31, 2024. The content of the aforementioned application, including any intervening amendments thereto, is incorporated herein by reference.

### TECHNICAL FIELD

The present disclosure relates to a coupling device for a multi-channel optical fiber array and a multi-layer arrayed waveguide grating, and an optical transceiver module, which belongs to the field of optical transceiver module technologies.

### BACKGROUND

With the rapid advancement of big data and artificial intelligence (AI), a requirement for data flow continues to grow, and a transmission rate of an optical transceiver module increases accordingly. Currently, the transmission rate of the optical transceiver module has reached 800 Gbps. However, to meet higher requirements of data centers, cloud computing, and other fields in the future, major manufacturers are continuously exploring optical transceiver module technologies with higher transmission rates. Technologies for increasing the data transmission rate of optical transceiver module primarily include a wavelength division multiplexing technology and a multi-channel parallel transmission technology.

In the wavelength division multiplexing technology, wavelength characteristics of light are utilized to transmit signals of different wavelengths on one optical fiber. In the optical transceiver module, an electrical signal is converted by a laser into an optical signal, and optical signals of various wavelengths are combined by an optical multiplexer for transmission in an optical fiber. On a receiver, different wavelengths are separated, thereby increasing data transmission capacity and increasing the data transmission rate. However, the wavelength division multiplexing technology has some disadvantages, for example, a requirement for high-precision light sources and optical filters, leading to high costs, a high requirement for light source stability and wavelength maintenance, and problems such as crosstalk and dispersion.

Another technology for increasing the transmission rate is the multi-channel parallel transmission technology. In this technology, a plurality of channels are utilized to simultaneously transmit data, thereby increasing a transmission bandwidth and a transmission speed. An optical wavelength signal emitted by the optical transceiver module is split by a splitter into different channels for simultaneous transmission over a plurality of optical fibers, thereby increasing the transmission bandwidth. However, the multi-channel parallel transmission technology also has some disadvantages such as a requirement for more optical fibers and optical transceivers, increasing system complexity and costs. Parallel channels may have timing delay differences and crosstalk problems. Therefore, complex signal multiplexing and demultiplexing techniques are required.

An existing optical transceiver module product is designed into an optical fiber array structure with four or eight parallel transmission channels, or a four-channel wavelength division multiplexing transmission structure for multiplexing or demultiplexing. An optical signal power at a transmitter or a baud rate per channel is continuously increased, to further increase the transmission rate of the optical transceiver module. However, this increases power consumption of the optical transceiver module, and is not conductive to increase of the data transmission rate of the optical transceiver module. Therefore, there is an urgent need to develop a new optical transceiver module structure to increase the data rate of the optical transceiver module more effectively.

### SUMMARY OF PRESENT INVENTION

Aiming at the defects in the prior art, an objective of the present disclosure is to provide a coupling device for a multi-channel optical fiber array and a multi-layer arrayed waveguide grating, and an optical transceiver module, integrating a wavelength division multiplexing technology with a multi-channel parallel transmission technology. The designed coupling device is used in the optical transceiver module, to transmit large-capacity signals and increase a transmission rate of the optical transceiver module.

A technical solution adopted in the present disclosure is as follows: The present disclosure provides a coupling device for a multi-channel optical fiber array and a multi-layer arrayed waveguide grating, including: a first clamping component configured to fasten an optical fiber array comprising a plurality of optical fibers, and a second clamping component configured to fasten arrayed waveguide gratings, where the first clamping component is configured to connect the plurality of optical fibers, space them apart in an X-axis direction, and enable each optical fiber extends in a Y-axis direction; of the second clamping component is configured to connect the arrayed waveguide gratings, space them apart in the X-axis direction, and enable each arrayed waveguide grating extends in the Y-axis direction; the first and second clamping components are structured to make the optical fibers and the arrayed waveguide gratings disposed in a one-to-one coaxial mapping manner; and each arrayed waveguide grating is right-trapezoid-shaped, and the second clamping component is structured to enable beveled surfaces of any two arrayed waveguide gratings being located on a same plane.

In one embodiment, the first clamping component includes a base, a pressing plate, and a cover plate, where the base is provided with optical fiber mounting slots that are in one-to-one correspondence with the optical fibers of the optical fiber array, and the pressing plate and the cover plate are fixedly connected above the base.

In one embodiment, the second clamping component includes a first side plate, a second side plate, a first fastening cover plate, a second fastening cover plate, and a glass plate, the first side plate and the second side plate are spaced apart in a Z-axis direction, the glass plate is parallel to an XY plane, and the first fastening cover plate and the second fastening cover plate are disposed outside the first side plate, the second side plate, and the glass plate.

In one embodiment, there are four optical fibers, and there are four arrayed waveguide gratings.

In one embodiment, the glass plate is fixedly connected to end faces of two outermost arrayed waveguide gratings on the X-axis direction.

In one embodiment, a side end face angle α of each optical fiber of the optical fiber array is designed to correspond to a light-incident end face angle θ of the arrayed waveguide grating, and a center-to-center pitch p of two adjacent optical fiber mounting slots corresponds to a thickness h of the arrayed waveguide grating.

In one embodiment, the light-incident end face angle θ of the arrayed waveguide grating is obtained by:

$$η = \frac{2 R cos 2 θ}{1 + {( cos 2 θ )}^{2}} exp [ - \frac{{( sin 2 θ )}^{2}}{2 ( 1 + {( cos 2 θ )}^{2} )} * {( n 1 * K * {ω}_{0} )}^{2} ] ,$$

where R=3.58%, K is a wave vector phase constant, K=2π/λ, ω₀ is a beam waist radius of a Gaussian beam, n is a reflectance of an end face of the arrayed waveguide grating, n1 is an effective refractive index of the arrayed waveguide grating, and λ is a wavelength.

In one embodiment, a light-emergent end face angle β of the arrayed waveguide grating is equal to 30°.

In one embodiment, when the first and second clamping components are respectively connected with the optical fiber and the arrayed waveguide grating, the optical fiber is fit with an input channel surface of the arrayed waveguide grating, and the optical fiber is aligned and coupled with a light—incident of the arrayed waveguide grating through a three-dimensional adjusting bracket.

The present disclosure further provides an optical transceiver module, including the coupling device described above.

The present disclosure has the following beneficial effects: By integrating the wavelength division multiplexing technology with the multi-channel parallel transmission technology, a large-capacity signal can be transmitted in the optical transceiver module, thereby significantly increasing the transmission rate of the optical transceiver module. Specifically, four layers of arrayed waveguide gratings are stacked to form a grating array assembly according to embodiments of the present disclosure, where four wavelengths are output by the arrayed waveguide gratings on each layer. The four-layer grating array assembly is coupled to a four-channel optical fiber array, enabling simultaneous transmission of a total of sixteen wavelength signals.

The coupling device for a multi-channel optical fiber array and a multi-layer arrayed waveguide grating is adopted in the present disclosure. The coupling device includes the first clamping component configured to fasten the optical fiber array and the second clamping component configured to fasten arrayed waveguide gratings. The first clamping component is configured to connect the plurality of optical fibers, space them apart in the X-axis direction, and enable each optical fiber extends in the Y-axis direction. The second clamping component is configured to connect the plurality of arrayed waveguide gratings, space them apart in the X-axis direction, and enable each arrayed waveguide grating extends in the Y-axis direction. The first and second clamping components are structured to make the optical fibers and the arrayed waveguide gratings disposed in a one-to-one axial mapping manner, each arrayed waveguide grating is right-trapezoid-shaped, and the second clamping component is structured to enable beveled surfaces of any two arrayed waveguide gratings are located on a same plane.

In this structure, the optical fiber array is precisely coupled with the multi-layer arrayed waveguide grating, and the transmission rate of the optical transceiver module is increased through multi-channel parallel transmission. In addition, with the adoption of an arrayed waveguide grating design, the problems of crosstalk and dispersion in the wave division multiplexing technology can also be effectively avoided. In addition, coupling details, for example, angle matching, end face reflective index control, and the like, between the optical fiber and the arrayed waveguide grating are further optimized, to further improve coupling efficiency.

Further, an optical fiber array channel pitch in the present disclosure is designed to match a thickness of the arrayed waveguide grating, thereby maximizing coupling efficiency of an optical signal. In addition, the light-emergent end face angle of the arrayed waveguide grating in this structural design in the present disclosure enables a light-emergent distance to simultaneously meet both an assembly distance and mounting space between a photodetector (PD) at the receiver and a laser diode (LD) at the transmitter within the optical transceiver module. An optical transmission component can be directly mounted in the optical transceiver module to implement functions.

In conclusion, according to the coupling device for a multi-channel optical fiber array and a multi-layer arrayed waveguide grating provided in the present disclosure, the technical bottleneck of the optical transceiver module in increasing the transmission rate can be effectively resolved, and a feasible resolution is provided for a next-generation high-speed optical transceiver module.

### BRIEF DESCRIPTION OF THE DRAWINGS

The present disclosure is described in further detail with reference to the accompanying drawings and embodiments. In the drawings:

FIG. 1 is a package diagram of a device according to the present disclosure;

FIG. 2 is a diagram showing components of a device according to the present disclosure;

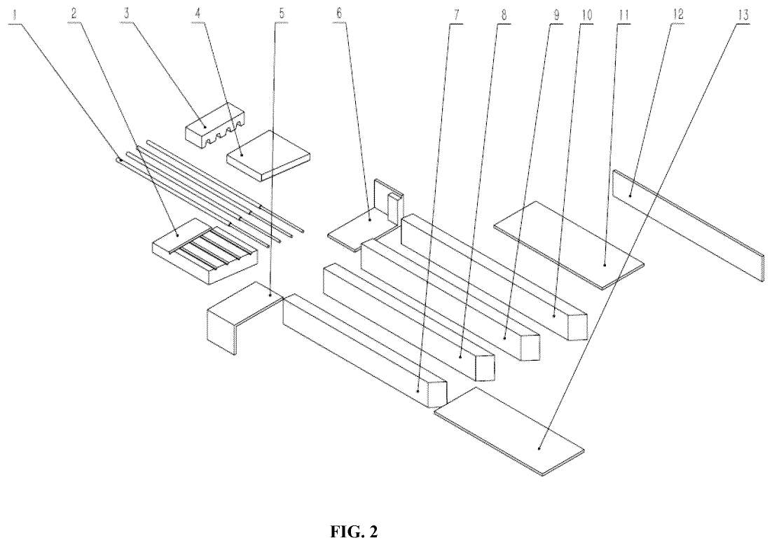

FIG. 3 is a schematic diagram showing optical path propagation within a device according to the present disclosure; and

FIG. 4 is a diagram showing a mounting arrangement according to the present disclosure within an exemplary optical transceiver module.

### DETAILED DESCRIPTION OF THE EMBODIMENTS

In order to make the objectives, technical solutions, and advantages of the present disclosure clearer, the present disclosure is further described in detail below with reference to the accompanying drawings and examples. It should be understood that the specific embodiments described herein are intended merely to explain the present disclosure, rather than to limit the present disclosure.

The present disclosure provides a coupling device for a multi-channel optical fiber array and a multi-layer arrayed waveguide grating and an optical transceiver module, and specifically, provides an optical transmission component that can increase a transmission rate of the optical transceiver module. According to the present disclosure, a four-core optical fiber array is combined with a multi-layer arrayed waveguide grating to form sixteen transmission channels in total that may be eight transmitter channels and eight receiver channels, or may be sixteen transmitter channels or sixteen receiver channels. In this way, a transmission rate limitation problem of the optical transceiver module is resolved. To achieve the objective, the optical fiber array is combined with the multi-layer arrayed waveguide grating, and each channel of the optical fiber array is coupled with the arrayed waveguide grating layer on one layer to split one signal into four optical signals with different wavelengths to carry more data information. The plurality of layers of arrayed waveguide gratings are sequentially stacked, are clamped by glass plates on two sides, and are bonded and fastened with adhesive, to form one arrayed waveguide grating array component. Then, a plurality of optical signals from the optical fiber array are simultaneously coupled by a three-dimensional coupling adjusting bracket into an input end of the multi-layer arrayed waveguide grating. Finally, a plurality of wavelength signals are output from an output end of the arrayed waveguide grating. In this way, more data signals can be simultaneously transmitted by the optical transceiver module, to increase a transmission capacity and a transmission rate of the optical transceiver module.

### Embodiment 1

The present disclosure provides a coupling design for a multi-channel optical fiber array and a multi-layer arrayed waveguide grating. A group of fibers are assembled into an array. The coupling device includes two main components: a first clamping component and a second clamping component.

The first clamping component includes a base 2, a pressing plate 3, and a cover plate 4. The base 2 adopts a novel Z-shaped structural design, and four optical fiber mounting slots that are spaced apart in an X-axis direction and that are in one-to-one correspondence with four optical fibers 1 of an optical fiber array are disposed on the base 2. In this way, not only can the optical fiber array be stably fastened, but also the optical fibers be precisely aligned with subsequent arrayed waveguide gratings.

It should be noted that, each optical fiber 1 has outer buffer layers removed. The mounted fibers are matched to the geometric characteristics of the arrayed waveguide grating, to improve coupling efficiency between the optical fiber and the arrayed waveguide grating. Specifically, a side end face angle α of the optical fiber 1 is designed to correspond to a light-incident end face angle θ of the arrayed waveguide grating, thereby implementing precise angle matching between the optical fiber and the arrayed waveguide grating.

After the optical fibers 1 are fastened to the base 2, the pressing plate 3 and the cover plate 4 are fixedly connected above the base 2 separately, to form a stable optical fiber fastening structure. In this way, not only can the optical fiber array be stably fastened, but also the optical fibers be highly matched with subsequent arrayed waveguide gratings through a precise structural design.

The second clamping component includes a first side plate 11, a second side plate 13, a first fastening cover plate 5, a second fastening cover plate 6, and a glass plate 12. The first side plate 11 and the second side plate 13 are spaced apart in a Z-axis direction, to form a clamping cavity. In the clamping cavity, four arrayed waveguide gratings that are spaced apart in an X-axis direction are mounted. Each arrayed waveguide grating is a right-trapezoid-shaped structure, and beveled surfaces of any two arrayed waveguide gratings are located on a same plane.

To protect and package the arrayed waveguide gratings, especially the outermost two arrayed waveguide gratings, the glass plate 12 is adopted by the second clamping component as a package material. The glass plate 12 is parallel to an XY plane, and the first fastening cover plate 5 and the second fastening cover plate 6 are disposed outside the glass plate 12. In this way, not only can the arrayed waveguide grating be stably fastened, but also the arrayed waveguide grating be effectively protected, thereby improving structural stability and facilitating transmission of an optical signal.

The first clamping component and the second clamping component are precisely aligned and coupled with each other, to form a core creative point of the present disclosure. Specifically, four optical fibers 1 and four arrayed waveguide gratings are coupled with each other in one-to-one correspondence, thereby implementing effective coupling of the optical signal. The four arrayed waveguide gratings are a first arrayed waveguide grating 7, a second arrayed waveguide grating 8, a third arrayed waveguide grating 9, and a fourth arrayed waveguide grating 10. Projections of the first arrayed waveguide grating 7, the second arrayed waveguide grating 8, the third arrayed waveguide grating 9, and the fourth arrayed waveguide grating 10 on the XY plane are right-trapezoid-shaped. Lengths of the first arrayed waveguide grating 7, the second arrayed waveguide grating 8, the third arrayed waveguide grating 9, and the fourth arrayed waveguide grating 10 are unequal. An end face that is of the first arrayed waveguide grating 7 and that is perpendicular to the X-axis direction corresponds to an end face that is of the second arrayed waveguide grating 8 and that is perpendicular to the X-axis direction. The end face that is of the second arrayed waveguide grating 8 and that is perpendicular to the X-axis direction corresponds to a face that is of the third arrayed waveguide grating 9 and that is perpendicular to the X-axis direction. The end face that is of the third arrayed waveguide grating 9 and that is perpendicular to the X-axis direction corresponds to an end face that is of the fourth arrayed waveguide grating 10 and that is perpendicular to the X-axis direction. The two end faces that correspond to each other in shape are two adjacent end faces that are attached to each other.

In this structural design, a wavelength division multiplexing technology is delicately combined with a multi-channel parallel transmission technology. First, four optical signals with different wavelengths can be output by each arrayed waveguide grating by using the wavelength division multiplexing technology. The four arrayed waveguide gratings are connected together in parallel, and therefore, 16 optical signals with different wavelengths can be simultaneously transmitted by the entire optical transceiver module. This greatly increases a transmission capacity of the optical transceiver module.

Then, four optical fibers 1 and four arrayed waveguide gratings are coupled with each other in one-to-one correspondence in a multi-channel parallel transmission manner, thereby implementing multi-channel parallel transmission. This can not only further increase an overall transmission rate of the optical transceiver module, but also effectively avoid problems of crosstalk and dispersion in the wavelength division multiplexing technology.

It should be noted that, coupling details between the optical fiber 1 and the arrayed waveguide grating are optimized finely. First, a center-to-center pitch p of two adjacent optical fiber mounting slots is designed to be highly consistent with a thickness h of the arrayed waveguide grating, thereby maximizing coupling efficiency of an optical signal.

Then, as mentioned above, a side end face angle α of the optical fiber 1 is designed to correspond to a light-incident end face angle θ of the arrayed waveguide grating, thereby implementing precise angle matching between the optical fiber and the arrayed waveguide grating. The precise angle matching not only can improve coupling efficiency to a maximum extent, but also help reduce loss of the optical signal in a coupling process.

According to the present disclosure, an output end face angle β of the arrayed waveguide grating is also optimized finely. Designing β to 30° enables a light emergent distance to simultaneously meet requirements for an assembly distance at a transmitter laser diode (LD) and a receiver photodetector (PD) within the optical transceiver module, thereby greatly simplifying an integral structure and mounting space of the optical transceiver module.

In conclusion, according to the coupling device for a multi-channel optical fiber array and a multi-layer arrayed waveguide grating disclosed in the present disclosure, advantages of the wavelength division multiplexing technology and the multi-channel parallel transmission technology are sufficiently brought into effect through meticulous design and optimization, thereby greatly increasing the transmission rate of the optical transceiver module. A Z-shaped structural design of the first clamping component, a step shaft shaped structure of the optical fiber 1, a composite structural design of the second clamping component, and optimized parameters of the arrayed waveguide grating are core creative points of the present disclosure.

### Embodiment 2

In this embodiment, glass plates 12 are fixedly connected to end faces of two outermost arrayed waveguide gratings on the X-axis direction. This structural design archives the following technical effects.

First, a stacking structure for four layers of arrayed waveguide gratings is adopted in the present disclosure. During assembly, the four layers of gratings are pressed vertically via a tool, and one glass plate 12 is bonded to each of two sides, to fasten the entire structure as a whole.

The advantages of this design are that distances between the four layers of arrayed waveguide gratings can be kept highly consistent. It is difficult to precisely control a thickness of an adhesive layer if the grating on each layer is bonded with adhesive, and consequently, a non-uniform inter-layer distance problem is likely to occur. Coupling efficiency between the optical fiber array and the arrayed waveguide grating is reduced due to non-uniformity.

According to the present disclosure, the glass plates 12 are bonded on the outermost arrayed waveguide gratings, so that not only can the entire arrayed waveguide grating structure be fastened, but also a spacing between the gratings be precisely controlled. This not only improves structural stability, but also ensures efficient coupling between the optical fiber and the arrayed waveguide grating. In addition, the glass plate 12 further can achieve a protective effect. As a core optical element, the arrayed waveguide grating is likely to be damaged due to inference of an external environment. Adding the glass plate 12 can effectively isolate the arrayed waveguide grating from the external environment, and therefore, reliability of the entire optical transmission system is improved.

According to the present disclosure, the glass plates 12 are added on the two sides, and therefore, the structural design of the arrayed waveguide grating in the present disclosure is further optimized in Embodiment 2. This not only ensures a precisely consistent spacing between the gratings and improves coupling efficiency between the optical fiber and the grating, but also improves stability and reliability of the entire optical transmission system.

In comparison with Embodiment 1, in Embodiment 2, the arrayed waveguide grating structure is further optimized while characteristics of core structures such as the multi-channel optical fiber array and the multi-layer arranged waveguide grating are kept, thereby further improving performance indicators of the present disclosure.

### Embodiment 3

In this embodiment, a side end face angle α of each optical fiber 1 of the optical fiber array is designed to correspond to a light-incident end face angle θ of the arrayed waveguide grating. In addition, a center-to-center pitch p of the optical fiber mounting slot and a thickness h of the arrayed waveguide grating are kept consistent.

An objective of this design is to implement precise angle matching and spacing matching between the optical fiber and the arrayed waveguide grating, thereby improving coupling efficiency of the optical signal to a maximum extent.

Specifically, the side end face angle α of the optical fiber 1 is completely matched with the light-incident end face angle θ of the arrayed waveguide grating. This angle matching not only helps reduce a loss of the optical signal in a coupling process, but also helps improve coupling efficiency of the optical signal.

In addition, the center-to-center pitch p of the optical fiber mounting slot is designed to be highly consistent with the thickness h of the arrayed waveguide grating. In this way, the optical fiber 1 and the arrayed waveguide grating precisely correspond to each other in spatial position, thereby ensuring efficient transmission of the optical signal in the coupling process.

In addition, a wavelength channel spacing (an output waveguide pitch) of the arrayed waveguide grating is further optimized in the present disclosure. The spacing is designed to x, and crosstalk and an insertion loss between grating wavelengths are affected by different spacing designs.

It should be noted that, input end faces and output end faces of four layers of arrayed waveguide gratings are further required to be flush to each other in the present disclosure. This design can further ensure high consistency between the arrayed waveguide gratings, avoiding degradation in coupling efficiency due to uneven height.

In conclusion, the coupling details between the optical fiber and the arrayed waveguide grating are precisely optimized in Embodiment 3 on the basis of keeping characteristics of core structures in Embodiment 1 and Embodiment 2. Transmission efficiency of the optical signal in the coupling process is further improved in the present disclosure through angle matching, spacing matching, and wavelength channel spacing optimization.

This optimized design not only helps increase the transmission rate of the entire optical transceiver module, but also improves stability and reliability of the system.

### Embodiment 4

The present disclosure provides a method for manufacturing an arrayed waveguide grating by using the following manufacturing process. Specifically, first, a layer of silicon dioxide film is deposited on a glass substrate or a silicon substrate. Then, an input waveguide, an intermediate Rowland circle grating, and an output waveguide are manufactured on the silicon dioxide film by using photolithography or reactive-ion etching (RIE).

Finally, a four-channel arrayed waveguide grating is finally formed through a series of processes. It should be noted that four layers of such arrayed waveguide gratings are used in total in the present disclosure, and are sequentially stacked together. Each layer of arrayed waveguide grating has a same thickness, but different lengths.

To further protect the arrayed waveguide gratings, a glass plate is bonded above the uppermost layer of arrayed waveguide gratings. This can effectively protect an arrayed waveguide grating region etched on the surface of the substrate, and improves structural stability.

In addition, one flat glass plate is bonded on each of two sides of the stacked four layers of arrayed waveguide gratings. In this way, the four layers of arrayed waveguide gratings form an integral component structure.

The manufacturing process and structural design fully demonstrate the innovative nature of the present disclosure. First, an integrated manufacturing process can be adopted to greatly improve production efficiency and reduce costs. Then, in the multi-layer stacked design, transmission channels are added, and stability and reliability of the entire system are also improved through protection of the glass plate.

In conclusion, Embodiment 4 exemplifies a further innovative breakthrough of the present disclosure in both manufacturing process and structural design.

### Embodiment 5

In addition to the aforementioned structural innovation, the present disclosure also provides a novel solution for the assembly process of an optical transmission system. Specifically, a fixed connection of the entire structure is implemented by using four kinds of different ultraviolet (UV) adhesives.

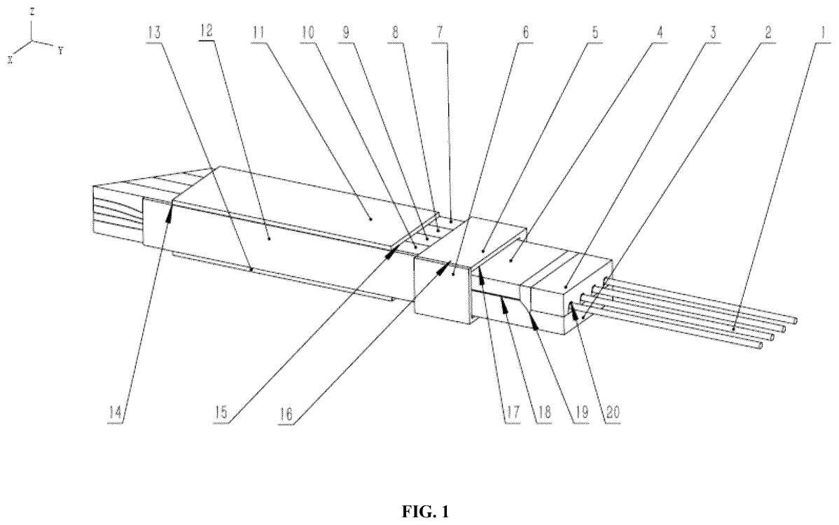

First, the first UV adhesive is mainly used in the following: 1) tight stacking between arrayed waveguide gratings, and bonding between the first side plate 11 and the second side plate 13; 2) bonding between the uppermost layer of arrayed waveguide gratings 10 and the glass plate 12; and 3) a coupling region between the arrayed waveguide grating and the optical fiber array, and combined bonding between the first fastening cover plate 5 and the second fastening cover plate 6. Adhesive dispensing positions of the first UV adhesive is as shown in FIG. 1, and are a first adhesive dispensing region 14, a second adhesive dispensing region 15, and a third adhesive dispensing region 16.

The second UV adhesive is used for coupled bonding between an arrayed waveguide grating component and an end face of the optical fiber array, and an adhesive dispensing position is as shown in a fourth adhesive dispensing region 17 in FIG. 1.

The third UV adhesive adopts a rigid structural bonding formulation, and is used for connecting the optical fiber mounting slot to the cover plate 4. An adhesive dispensing position is shown in a fifth adhesive dispensing region 18 in FIG. 1.

Finally, the fourth UV adhesive is used for bonding between the optical fiber mounting slot and the pressing plate 3, and bonding between the pressing plate 3 and the cover plate 4. Adhesive dispensing positions are shown in a sixth adhesive dispensing region 19 and a seventh adhesive dispensing region 20 in FIG. 1.

This design, which adopts four different types of UV adhesives, sufficiently addresses bonding requirements between various components of the entire optical transmission system. Through the targeted selection of UV adhesives with different properties, not only can firm connection between structural components be ensured, but also stability and reliability of the entire system be improved.

### Embodiment 6

This embodiment provides a design method for a light-incident end face angle θ of an arrayed waveguide grating. The light-incident end face angle θ of an arrayed waveguide grating is obtained by:

$$η = \frac{2 R cos 2 θ}{1 + {( cos 2 θ )}^{2}} exp [ - \frac{{( sin 2 θ )}^{2}}{2 ( 1 + {( cos 2 θ )}^{2} )} * {( n 1 * K * {ω}_{0} )}^{2} ] ,$$

R=3.58%, K is a wave vector phase constant, K=2π/λ, ω₀ is a beam waist radius of a Gaussian beam, η is a reflectance of an end face of the arrayed waveguide grating, n1 is an effective refractive index of the arrayed waveguide grating, and λ is a wavelength.

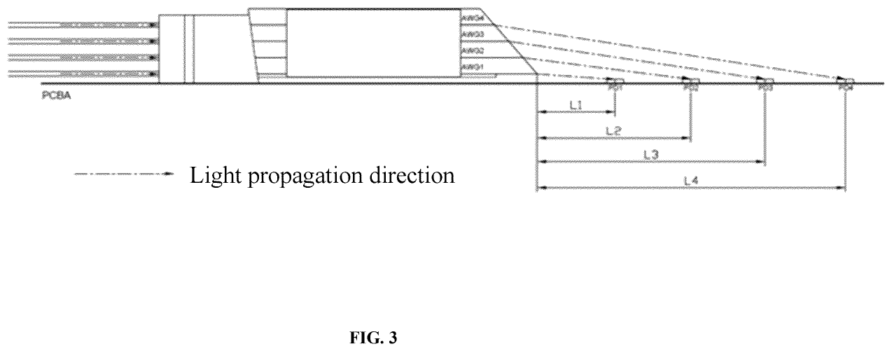

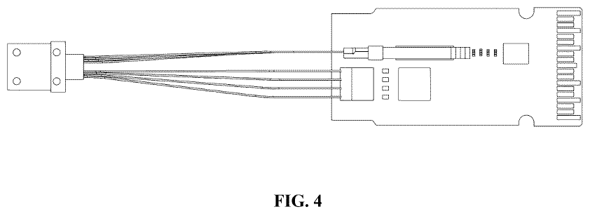

As shown in FIG. 3 and FIG. 4, an output end face angle of the arrayed waveguide grating in the present disclosure is designed as β. According to a refractive index formula, h is a thickness of the arrayed waveguide grating, b is a parallel height difference between the arrayed waveguide grating and the optical fiber array, no is a refractive index of a light-emergent medium, ni is a refractive index of a light-incident medium, and a theoretical value of a PD receiving position Ln on the horizontal plane can be calculated according to the formula. In this case, a horizontal light-emergent distance difference between of each layer of arrayed waveguide grating on a silicon photonics chip is Lx=Ln−Ln−1 (n=1, 2, 3 . . . ). By utilizing theoretically calculated values, laser diode (LD) chips and photodetector (PD) chips are integrated at different positions on the silicon photonics chip.

$$Ln = ( n - 1 ) * ( h + b ) / TAN ( ASIN ( sin ( θ ) * ni / no ) - β ) - ( n - 1 ) * ( h + b ) / TAN ( 90 - β ) ,$$

$$n = 1 , 2 , 3 …$$

In the present disclosure, the optical fiber array is positioned vertically for coupling with the arrayed waveguide grating. The side end face angle is designed as α=θ, and a center-to-center pitch of V-groove channels in the optical fiber array is designed as p=h, and is consistent with the thickness of the arrayed waveguide grating. During coupling, each channel in the optical fiber array is attached to an input channel surface of the arrayed waveguide grating on each layer. An optical fiber in each V-groove in the optical fiber array is aligned and coupled with a light-incident port of the arrayed waveguide gratings on each layer through a three-dimensional adjusting bracket.

In a preferred embodiment of the present disclosure, the thickness of the arrayed waveguide grating is designed as h=0.75 mm, the light-incident end face angle of the arrayed waveguide grating is designed as θ=8°, light-emergent end face angle of the arrayed waveguide grating is designed as β=30°, and the center-to-center pitch of V-groove channels in the optical fiber array is designed as p=h.

In the present disclosure, four layers of arrayed waveguide gratings are stacked. During assembly, the gratings are pressed vertically through a tool, and glass plates are respectively bonded on two sides of the gratings stacked to form a whole. In this case, a distance between every two layers of arrayed waveguide gratings is ensured to be highly consistent. This avoids uncontrollable adhesive layer thickness and degradation in coupling efficiency between optical fiber arrays due to adhesive bonding between the upper and lower arrayed waveguide gratings.

In the prevent disclosure, the assembly of the optical fiber array involves positioning the optical fiber array on its side for coupling with the arrayed waveguide grating. The end face angle of the optical fiber array needs to be processed to 8 degrees. Furthermore, a grooved cover plate is added to the optical fiber array, and is used to bond with a 250-μm optical fiber at the ledge of the V-groove. In this case, when the optical fiber array is positioned on its side, optical fibers inside the optical fiber array are in a sealed and protected state. This enhances tensile strength resistance of the optical fibers and reduces the risk of optical fiber breakage when the optical array is integrated into an optical transceiver module.

It should be understood that the serial number of each step in the above embodiment does not indicate the sequence of performing the process. The sequence of performing each process is determined by its function and internal logic, and should not limit the implementation of the embodiments of the present disclosure.

It should be understood that those of ordinary skill in the art can make improvements or transformations based on the above description, and all these improvements and transformations should fall within the protection scope of the appended claims of the present disclosure.

What is claimed is:

1. A coupling device for a multi-channel optical fiber array and a multi-layer arrayed waveguide grating, comprising:
a first clamping component configured to fasten an optical fiber array comprising a plurality of optical fiber (1); and
a second clamping component configured to fasten arrayed waveguide gratings;
wherein the first clamping component is configured to connect the plurality of optical fibers (1), space the plurality of optical fibers (1) apart in an X-axis direction, and enable each optical fiber (1) extends in a Y-axis direction;
the second clamping component is configured to connect the arrayed waveguide gratings, space the arrayed waveguide gratings apart in the X-axis direction, and enable each arrayed waveguide grating extends in the Y-axis direction;
the first and second clamping components are structured to make the optical fibers and the arrayed waveguide gratings disposed in a one-to-one coaxial mapping manner; and
each arrayed waveguide grating is right-trapezoid-shaped, and the second clamping component is structured to enable beveled surfaces of any two arrayed waveguide gratings being located on a same plane.

2. The coupling device according to claim 1, wherein the first clamping component comprises a base (2), a pressing plate (3), and a cover plate (4), the base (2) is provided with optical fiber mounting slots that are in one-to-one correspondence with the optical fibers (1), and the pressing plate (3) and the cover plate (4) are fixedly connected above the base (2).

3. The coupling device according to claim 1, wherein the second clamping component comprises a first side plate (11), a second side plate (13), a first fastening cover plate (5), a second fastening cover plate (6), and a glass plate (12), the first side plate (11) and the second side plate (13) are spaced apart in a Z-axis direction, the glass plate (12) is parallel to an XY plane, and the first fastening cover plate (5) and the second fastening cover plate (6) are disposed outside the first side plate (11), the second side plate (13), and the glass plate (12).

4. The coupling device according to claim 1, wherein there are four optical fibers (1), and there are four arrayed waveguide gratings.

5. The coupling device according to claim 1, wherein the glass plate (12) is fixedly connected to end faces of two outermost arrayed waveguide gratings on the X-axis direction.

6. The coupling device according to claim 2, wherein a side end face angle α of each optical fiber (1) is designed to correspond to a light-incident end face angle θ of each arrayed waveguide grating, and a center-to-center pitch p of two adjacent optical fiber mounting slots corresponds to a thickness h of the arrayed waveguide grating.

7. The coupling device according to claim 6, wherein the light-incident end face angle θ of the arrayed waveguide grating is obtained by:
$$η = \frac{2 R cos 2 θ}{1 + {( cos 2 θ )}^{2}} exp [ - \frac{{( sin 2 θ )}^{2}}{2 ( 1 + {( cos 2 θ )}^{2} )} * {( n 1 * K * {ω}_{0} )}^{2} ] ,$$
wherein R=3.58%, K is a wave vector phase constant, K=2π/λ, ω₀ is a beam waist radius of a Gaussian beam, n is a reflectance of an end face of the arrayed waveguide grating, n1 is an effective refractive index of the arrayed waveguide grating, and λ is a wavelength.

8. The coupling device according to claim 7, wherein a light-emergent end face angle β of the arrayed waveguide grating is equal to 30°.

9. The coupling device according to claim 1, wherein when the first and second clamping components are respectively connected with the optical fibers (1) and the arrayed waveguide gratings, each of the optical fibers (1) is fit with an input channel surface of each arrayed waveguide grating, and the optical fiber (1) is aligned and coupled with a light—incident port of the arrayed waveguide grating through a three-dimensional adjusting bracket.

10. An optical transceiver module, comprising the coupling device according to claim 1.
